(19) United States
(12) Patent Application Publication
(10) Pub. No.: US 2008/0128220 A1
(43) Pub. Date: Jun. 5, 2008

(54) Portable Wheel Chock

(76) Inventor: George S. Hartmann, Valencia, CA (US)

Correspondence Address: STETINA BRUNDA GARRED & BRUCKER, 75 ENTERPRISE, SUITE 250, ALISO VIEJO, CA, 92656, US

(21) Appl. No.: 11/566,012

(22) Filed: Dec. 1, 2006

(51) Int. Cl. B60T 3/00

(52) U.S. Cl. 188/32

(57) ABSTRACT

A portable wheel chock for partially accommodating and supporting a vehicle wheel. The wheel chock comprises a base plate which is configured to have at least a portion of the vehicle wheel rested thereupon. In addition to the base plate, the wheel chock comprises a support frame which is attached to the base plate and is configured to partially receive the vehicle wheel. The support frame itself includes a pair of elongate base portions which extend in spaced, generally parallel relation to each other and are each attached to the base plate. In addition to the base portions, the support frame includes a support portion which defines an opposed, generally parallel pair of arms, and a pair of arcuate portions which define the transition between the base portions and respective ones of the arms of the support portion. Also included in the support frame is a pair of anchor plates which are attached to respective ones of the arcuate portions so as to extend in spaced, generally parallel relation to each other and to the base plate. Each of the anchor plates includes a pair of apertures disposed therein.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND OF THE INVENTION

1. Field of the Invention

The present invention relates generally to wheel chocks, and more particularly to an improved wheel chock which is uniquely configured to enable quick and easy cooperative engagement to the storage bed of a transport vehicle such as a pick-up truck or trailer without requiring the rigid attachment of any component of the wheel chock to the storage bed.

2. Description of the Related Art

As is well known in the recreational industry, chocks are commonly used to support motorcycles for transportation on a vehicle such as a pick-up truck or trailer. In this regard, the rapidly increasing popularity of recreational motorcycle use has in turn resulted in an increasing need to transport motorcycles to various off-road recreational locations, such transport typically being effectuated through the use of pick-up trucks, trailers and the like. The prior art is replete with various types of make-shift holders, tie-downs and wheel chocks which have all been used in an effort to maintain adequate support to a motorcycle during transport. Though some of these prior art devices have achieved varying levels of success, the vast majority suffer from a lack of simplicity associated with their proper use.

Though wheel chock devices such as those disclosed in U.S. Pat. No. 3,785,516 to Brajkovich and U.S. Pat. No. 6,331,094 to Burrows have been developed in an attempt to achieve simplicity in use and ease in installation, such devices also possess certain deficiencies which detract from their overall utility. More particularly, these particular devices, and others similar thereto, include structural components which are adapted for permanent affixation to the storage bed of a pick-up truck or trailer. However, for many users, the need to permanently modify the storage bed of a pick-up truck or trailer by the advancement of various fasteners into one or more surfaces thereof is highly undesirable. Still further, such permanent attachment makes movement of the wheel chock to an alternative location (i.e., into the storage bed of another pick-up truck or trailer) a time consuming, cumbersome task.

The wheel chock constructed in accordance with the present invention overcomes these and other shortcomings in the prior art by providing a device of relatively simple and economical construction which can rapidly and easily be installed into and removed from within the storage bed of a transport vehicle without requiring the permanent affixation of any part or component of the device to such storage bed. These and other features and advantages of the present invention will be discussed in more detail below.

### BRIEF SUMMARY OF THE INVENTION

In accordance with the present invention, there is provided a portable wheel chock for partially accommodating and supporting a vehicle wheel. The wheel chock of the present invention comprises a base plate which is configured to have at least a portion of the vehicle wheel rested thereupon. In addition to the base plate, the wheel chock comprises a support frame which is attached to the base plate and is configured to partially receive the vehicle wheel. The support frame itself includes a pair of elongate base portions which extend in spaced, generally parallel relation to each other and are each attached to the base plate. In addition to the base portions, the support frame includes a support portion which defines an opposed, generally parallel pair of arms, and a pair of arcuate portions which define the transition between the base portions and respective ones of the arms of the support portion. Also included in the support frame is a pair of anchor plates which are attached to respective ones of the arcuate portions so as to extend in spaced, generally parallel relation to each other and to the base plate. Each of the anchor plates includes a pair of apertures disposed therein.

The present invention is best understood by reference to the following detailed description when read in conjunction with the accompanying drawings.

### BRIEF DESCRIPTION OF THE DRAWINGS

These, as well as other features of the present invention, will become more apparent upon reference to the drawings wherein:

FIG. 1 is a top, front perspective view of a wheel chock constructed in accordance with a first embodiment of the present invention;

FIG. 2 is a right side elevational view of the wheel chock shown in FIG. 1, further including a partial depiction in phantom of a motorcycle wheel as operatively engaged to the wheel chock;

FIG. 3 is a top plan view of the wheel chock shown in FIG. 1;

FIG. 4 is a front elevational view of the wheel chock shown in FIG. 1;

FIG. 5 is a left side elevational view of the wheel chock shown in FIG. 1;

FIG. 6 is a rear elevational view of the wheel chock shown in FIG. 1;

FIG. 7 is a bottom plan view of the wheel chock shown in FIG. 1;

FIG. 8 is a top, front perspective view of a wheel chock constructed in accordance with a second embodiment of the present invention;

FIG. 9 is a right side elevational view of the wheel chock shown in FIG. 8, further including a partial depiction in phantom of a motorcycle wheel as operatively engaged to the wheel chock;

FIG. 10 is a top plan view of the wheel chock shown in FIG. 8;

FIG. 11 is a front elevational view of the wheel chock shown in FIG. 8;

FIG. 12 is a left side elevational view of the wheel chock shown in FIG. 8;

FIG. 13 is a rear elevational view of the wheel chock shown in FIG. 8;

FIG. 14 is a bottom plan view of the wheel chock shown in FIG. 8; and

FIG. 15 is a top, rear perspective view of the wheel chock constructed in accordance with either the first or second embodiments of the present invention as operatively positioned in a storage bed of a transport vehicle and having the wheel of a motorcycle operatively interfaced thereto.

Common reference numerals are used throughout the drawings and detailed description to indicate like elements.

### DETAILED DESCRIPTION OF THE INVENTION

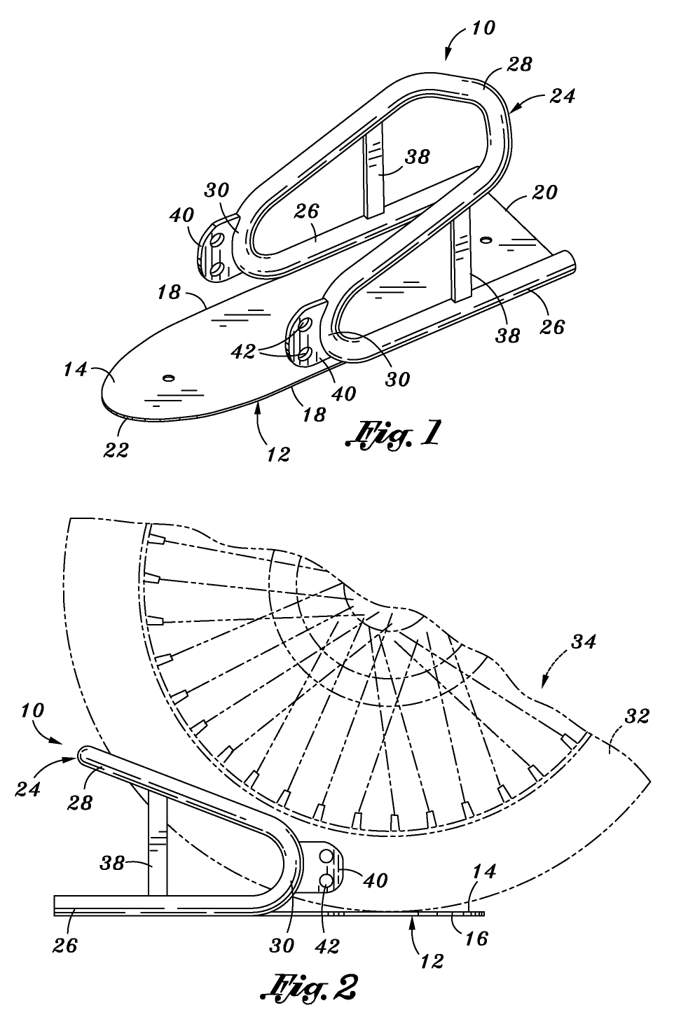

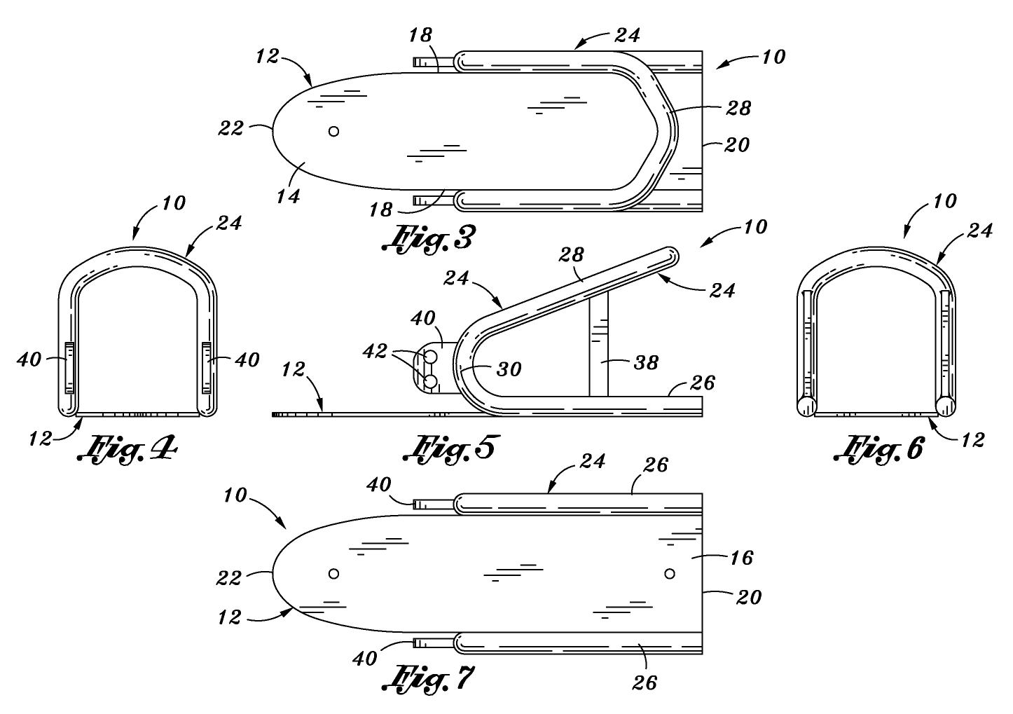

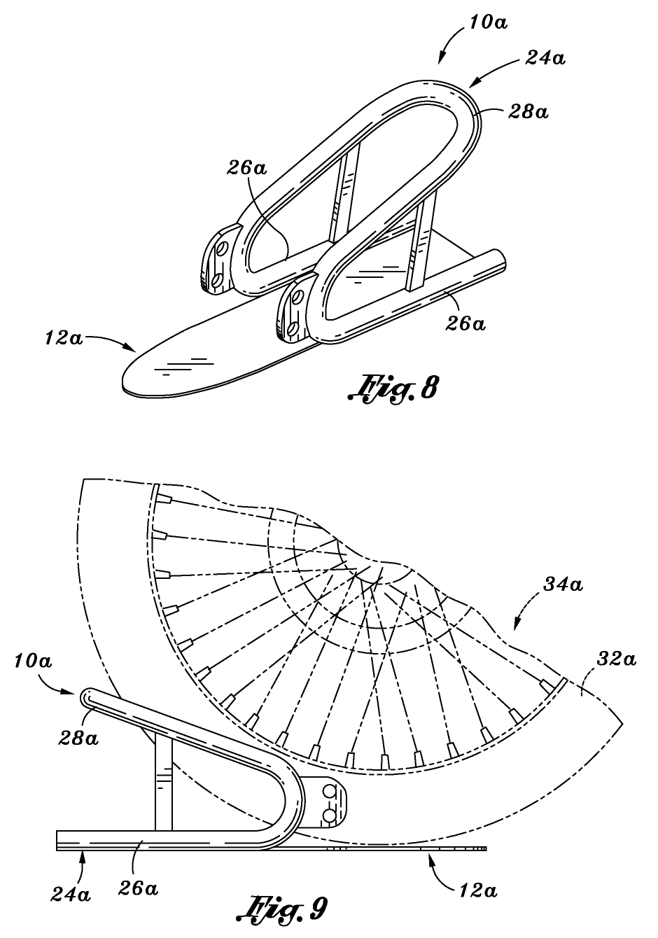

Referring now to the drawings wherein the showings are for purposes of illustrating preferred embodiments of the present invention only, and not for purposes of limiting the same, FIGS. 1-7 provide various views of a wheel chock 10 constructed in accordance with a first embodiment of the present invention. The wheel chock 10 comprises an elongate, generally planar base plate 12 which defines a generally planar top surface 14 and an opposed, generally planar bottom surface 16. The base plate 12 further defines a peripheral edge which includes a opposed pair of longitudinally extending edge portions 18, a laterally extending edge portion 20 which extends generally perpendicularly between corresponding ends of the longitudinal edge portions 18, and an arcuate edge portion 22 which transitions into those ends of the longitudinal edge portions 18 opposite those having the lateral edge portion extending therebetween.

In addition to the base plate 12, the wheel chock 10 comprises a support frame 24 which is rigidly attached to the base plate 12. More particularly, the support frame 24 comprises an elongate, cylindrically configured structural member which is bent so as to define a pair of base portions 26 which extend in spaced, generally parallel relation to each other. The structural member of the support frame 24, as bent, further defines a generally U-shaped support portion 28 which extends at an acute angle relative to the base portions 26. The transition between the support portion 28 and the base portions 26 is defined by an opposed, identically configured pair of arcuate portions 30 of the bent structural member. More particularly, each arcuate portion 30 defines the transition between one of the base portions 26 of the support frame 24 and a respective one of the spaced, generally parallel arms defined by the support portion 28.

As best seen in FIG. 3, the structural member used to form the support frame 24 is bent such that the distance separating the base portions 26 from each other is substantially identical to the distance separating the arms of the support portion 28 from each other. This distance substantially corresponds to the width of the base plate 12 as defined by the length of the lateral edge portion 20 thereof. In this regard, the attachment of the support frame 24 to the base plate 12 is preferably effectuated by extending the base portions 26 of the support frame 24 along respective ones of the longitudinal edge portions 18 of the base plate 12. The support frame 24 is further oriented such that the distal ends of the base portions 26 extend in a substantially flush or continuous relationship with the lateral edge portion 20 of the base plate 12. The length of the base plate 12 exceeds that of the support frame 24 such that the arcuate edge portion 22 of the base plate 12 extends well beyond the arcuate portions 30 of the support frame 24 when the support frame 24 is properly oriented relative to the base plate 12. Once the support frame 24 has been oriented relative to the base plate 12 in the above-described manner, the attachment of the support frame 24 to the base plate 12 is preferably effectuated through the use of welds. Those of ordinary skill in the art will recognize that the width of the base plate 12 and thus the distance separating the base portions 26 (and hence the arms of the support portion 28) from each other is sized as is necessary to accommodate yet provide a small level of clearance for the tire 32 of the wheel 34 of a motorcycle 36 or similar vehicle, as shown in FIGS. 2 and 15. It is contemplated that the structural member bent to form the base portions 26 and support portion 28 of the support frame 24, in addition to being cylindrically configured, may be tubular in construction for purposes of reducing the weight associated therewith.

In addition to the support portion 28, the support frame 24 of the wheel chock 10 includes an identically configured pair of support struts 38. Each of the support struts 38 is attached to and extends between one of the arms of the support portion 28 and a corresponding one of the base portions 26 in the manner best shown in FIG. 1. The attachment of the opposed ends of each support strut 38 to the base portion 26 and arm of the corresponding pair is preferably facilitated through the use of welds. The preferred location of each support strut 38 upon the corresponding base portion 26 is preferably approximately midway between the distal end of such base portion 26 and the arcuate portion 30 at the opposite end thereof. Though each of the support struts 38 shown in FIG. 1 has a generally rectangular cross-sectional configuration, those of ordinary skill in the art will recognize that alternative shapes for the support struts 38 are contemplated to be within the spirit and scope of the present invention. The support struts 38 are operative to prevent any undesirable deflection of the support portion 28 of the support frame 24 toward the base portions 26 thereof.

The support frame 24 of the wheel chock further comprises a pair of identically configured anchor plates 40 which are rigidly attached to respective ones of the arcuate portions 30 of the support frame 24 and project forwardly therefrom toward the arcuate edge portion 22 of the base plate 12 (and hence away from the support struts 38). The anchor plates 40 are attached to the arcuate portions 30 so as to extend in spaced, generally parallel relation to each other. The attachment of the anchor plates 40 to respective ones of the arcuate portions 30 is preferably facilitated through the use of welds as well. Disposed within each of the anchor plates 40 is a spaced pair of apertures 42. The anchor plates 40, including the apertures 42 therein, are adapted to accommodate portions of fastener straps 46 (shown in FIG. 15) used to assist in maintaining the operative engagement of the wheel 34 of the motorcycle 36 to the wheel chock 10, as will be described in more detail below.

The wheel chock 10 of the present invention is preferably fabricated from a rigid metal material, such as steel and stainless steel. It is also preferable that the wheel chock 10 be constructed from a material and/or coated with a suitable protectant as prevents any undesirable rusting or other corrosion thereof. Having previously described the structural attributes thereof, the preferred method of using the wheel chock 10 of the first embodiment will now be described with specific reference to FIGS. 2 and 15.

The use of the wheel chock 10 is facilitated by initially positioning the bottom surface 16 of the base plate 12 upon an underlying support surface 44, such as the lowermost surface of the storage bed of a pick-up truck or trailer. Once the base plate 12 has been positioned upon the support surface 44 in the manner shown in FIG. 15, the front wheel 34 of the motorcycle 36 (or similar vehicle) is advanced into the open interior of the support frame 24, i.e., is advanced between the base portions 26 and arms of the support portion 28 of the support frame 24. As will be recognized, as a result of such advancement, the tire 32 of the wheel 34 rests directly upon the top surface 14 of the base plate 12. In this position, the weight of the motorcycle 36 bearing down upon the base plate 12 assists in maintaining the wheel chock 10 in a prescribed location upon the support surface 44.

To assist in maintaining the position of the wheel chock 10 upon the support surface 44 as a result of the force exerted thereagainst by the motorcycle 36 itself, it is contemplated that conventional fastening straps 46 may be extended between prescribed locations of the motorcycle 36 (e.g., its handlebars) and corresponding existing attachment points 48 included on the support surface 44 or other locations in the vehicle storage bed. The anchor plates 40 of the support frame 24 are also adapted to provide a point of attachment for one end of a fastening strap 46, the opposite end of which is secured to an attachment point 48 in the storage bed. More particularly, either of the apertures 42 included in each of the anchor pads 40 is adapted to accommodate the hook which is typically included on each of the opposed ends of the fastening strap 46. As will be recognized by those of ordinary skill in the art, the extension of fastening straps 46 between each of the anchor plates 40 and respective attachment points 48 of the storage bed further assists in maintaining the wheel chock 10 in a prescribed position upon the support surface 44. The remaining apertures 42 of the pair included in each of the anchor plates 40 may be used to accommodate the hooks included on respective ones of the opposed ends of an additional fastening strap 46 which may be advanced about the wheel 34 or some other portion of the motorcycle 36 for purposes of preventing the removal of the wheel 34 from within the support frame 24 of the wheel chock 10.

As is apparent from the foregoing description, the use of the wheel chock 10 does not entail any permanent attachment or affixation of the base plate 12 to the support surface 44 of the storage bed, or any other portion thereof. Thus, upon the removal of the fastening straps 46, the wheel chock 10 may be simply lifted off of the support surface 44 and removed from within the storage bed.

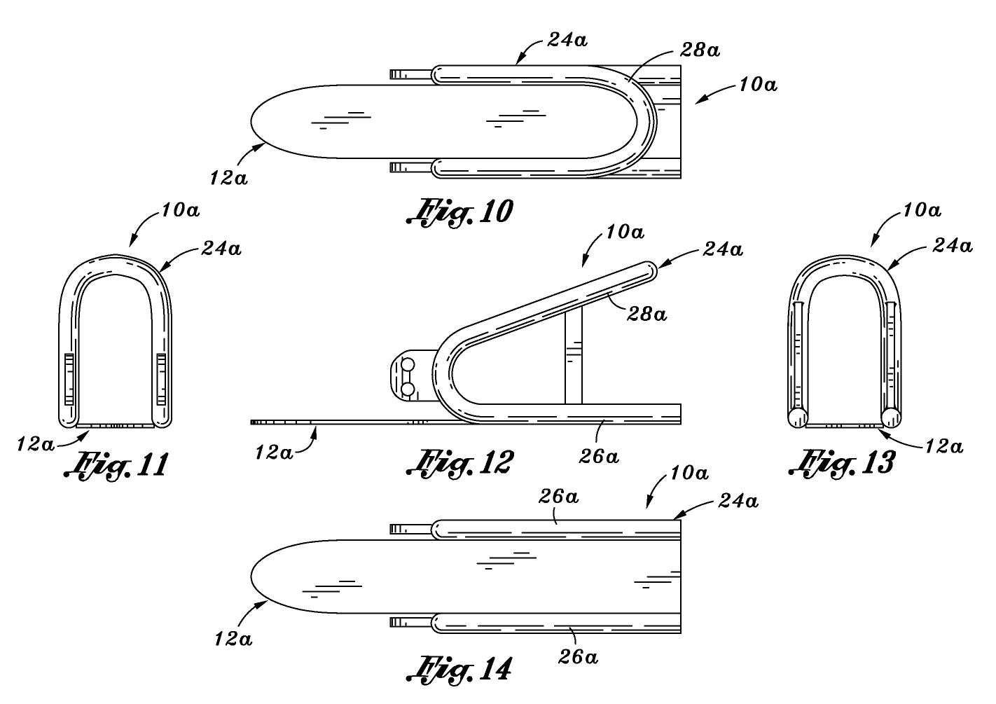

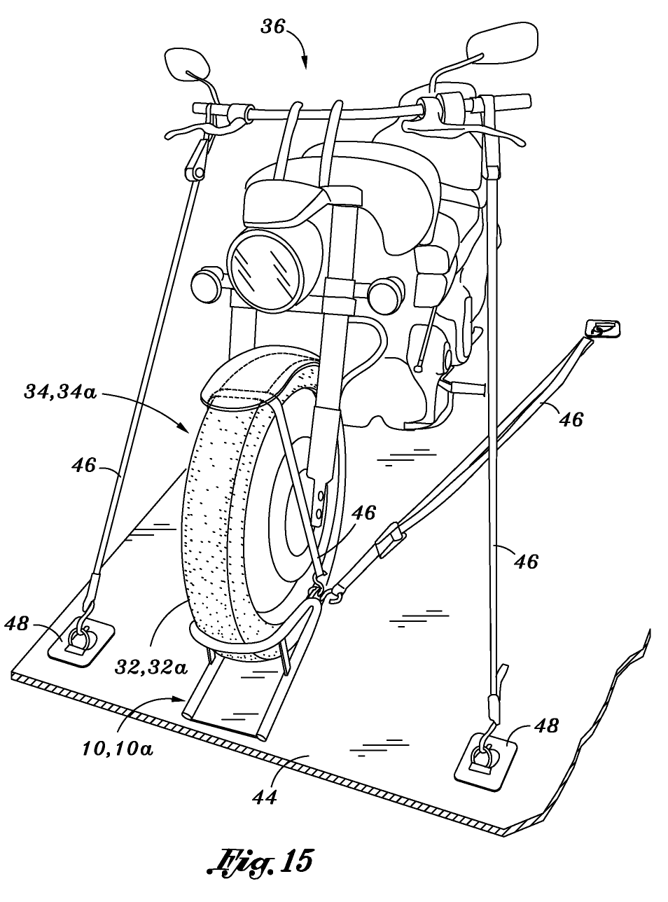

Referring now to FIGS. 8-14, there is shown a wheel chock 10a constructed in accordance with a second embodiment of the present invention. The wheel chock 10a of the second embodiment is substantially identical in construction and operation to the above-described wheel chock 10 of the first embodiment. As such, only the structural distinctions between the wheel chocks 10, 10a will be highlighted below.

The primary point of distinction between the wheel chock 10a and the wheel chock 10 lies in the base plate 12a of the wheel chock 10a being formed to be of a width which is less than that of the base plate 12 of the wheel chock 10. As a result, the distance separating the base portions 26a and the arms of the support portion 28a of the support frame 24a in the wheel chock 10a is reduced in comparison to the distance separating the base portions 26 and the arms of the support portion 28 in the support frame 24 of the wheel chock 10. Thus, as will be recognized, the wheel chock 10a of the second embodiment is adapted to accommodate a wheel 34a of smaller size including a tire 32a of reduced width in comparison to the tire 32 used in conjunction with the wheel chock 10 of the first embodiment.

This disclosure provides exemplary embodiments of the present invention. The scope of the present invention is not limited by these exemplary embodiments. Numerous variations, whether explicitly provided for by the specification or implied by the specification, such as variations in structure, dimension, type of material and manufacturing process may be implemented by one of skill in the art in view of this disclosure.

What is claimed is:

1. A portable wheel chock for partially accommodating and supporting a vehicle wheel, the wheel chock comprising:
a base plate configured to have at least a portion of the vehicle wheel rested thereupon; and
a support frame attached to the base plate and configured to partially receive the vehicle wheel, the support frame including:
a pair of anchor plates which extend in spaced relation to each other and to the base plate, each of the anchor plates including at least one aperture disposed therein.

2. The portable wheel chock of claim 1 wherein each of the anchor plates includes a spaced pair of apertures disposed therein.

3. The portable wheel chock of claim 1 wherein the support frame comprises an elongate structural member which is bent to define:
a pair of elongate base portions which extend in spaced, generally parallel relation to each other;
a generally U-shaped support portion defining an opposed, generally parallel pair of arms; and
a pair of arcuate portions defining the transition between the base portions and respective ones of the arms of the support portion.

4. The portable wheel chock of claim 3 wherein the anchor plates are attached to respective ones of the arcuate portions of the support frame.

5. The portable wheel chock of claim 3 wherein the support frame further includes a pair of support struts, each of which is attached to and extends between one of the base portions and a respective one of the arms of the support portion.

6. The portable wheel chock of claim 5 wherein the support portion of the support frame extends at an acute angle relative to the base portions thereof.

7. The portable wheel chock of claim 3 wherein the base plate includes a peripheral edge which defines:
an opposed, generally parallel pair of longitudinal edge portions;
a lateral edge portion which extends generally perpendicularly between the longitudinal edge portion; and
an arcute edge portion which extends between the longitudinal edge portions in opposed relation to the lateral edge portion.

8. The portable wheel chock of claim 7 wherein each of the base portions of the support frame is attached to and extends along a respective one of the longitudinal edge portions of the base plate.

9. The portable wheel chock of claim 8 wherein each of the base portions of the support frame is of a first length, and the base plate is of a second length which exceeds the first length.

10. The portable wheel chock of claim 8 wherein each of the base portions of the support frame defines a distal extends which extends in generally coplanar relation to the lateral edge portion of the base plate.

11. A portable wheel chock for partially accommodating and supporting a vehicle wheel, the wheel chock comprising:
a base plate configured to have at least a portion of the vehicle wheel rested thereupon; and
a support frame attached to the base plate and configured to partially receive the vehicle wheel, the support frame including:
a pair of elongate base portions which extend in spaced, generally parallel relation to each other and are attached to the base plate;
a support portion defining an opposed, generally parallel pair of arms;
a pair of arcuate portions defining the transition between the base portions and respective ones of the arms of the support portion; and
a pair of anchor plates which are attached to the support portion in spaced relation to each other and each include at least one aperture disposed therein.

12. The portable wheel chock of claim 11 wherein each of the anchor plates includes a spaced pair of apertures disposed therein.

13. The portable wheel chock of claim 11 wherein the support portion of the support frame has a generally U-shaped configuration.

14. The portable wheel chock of claim 11 wherein the anchor plates are attached to respective ones of the arcuate portions of the support frame.

15. The portable wheel chock of claim 11 wherein the support frame further includes a pair of support struts, each of which is attached to and extends between one of the base portions and a respective one of the arms of the support portion.

16. The portable wheel chock of claim 15 wherein the support portion of the support frame extends at an acute angle relative to the base portions thereof.

17. The portable wheel chock of claim 11 wherein the base plate includes a peripheral edge which defines:
an opposed, generally parallel pair of longitudinal edge portions;
a lateral edge portion which extends generally perpendicularly between the longitudinal edge portion; and
an arcute edge portion which extends between the longitudinal edge portions in opposed relation to the lateral edge portion.

18. The portable wheel chock of claim 17 wherein each of the base portions of the support frame is attached to and extends along a respective one of the longitudinal edge portions of the base plate.

19. The portable wheel chock of claim 18 wherein each of the base portions of the support frame is of a first length, and the base plate is of a second length which exceeds the first length.

20. The portable wheel chock of claim 18 wherein each of the base portions of the support frame defines a distal extends which extends in generally coplanar relation to the lateral edge portion of the base plate.
